(19) United States
(12) Patent Application Publication
(10) Pub. No.: US 2012/0055312 A1
(43) Pub. Date: Mar. 8, 2012

(54) BAND SAW HAVING ADJUSTABLE BLADE GUIDE

(75) Inventors: Akira MIZUTANI, Anjo-shi (JP); Kazunori TSUGE, Anjo-shi (JP); Koji MATSUBARA, Anjo-shi (JP); Akinori ITO, Anjo-shi (JP)

(73) Assignee: MAKITA CORPORATION, Anjo-shi (JP)

(21) Appl. No.: 13/216,783

(22) Filed: Aug. 24, 2011

(30) Foreign Application Priority Data
Sep. 6, 2010 (JP) 2010-198977

(51) Int. Cl. B23D 55/08

(52) U.S. Cl. 83/820

(57) ABSTRACT

A band saw has a housing, a pair of wheels rotatably disposed on the housing, a drive unit connected to one of the wheel, a continuous band saw blade supported by the wheels, and a guide movably attached to the housing. The guide is positioned to contact with the band saw blade in a thickness direction of the band saw blade in order to restrict movement of the band saw blade in its thickness direction.

### CROSS-REFERENCES TO RELATED APPLICATIONS

This application claims priority to Japanese patent application serial number 2010-198977, the contents of which are incorporated herein by reference.

### BACKGROUND OF THE INVENTION

### Field of the Invention

This disclosure relates to band saws each having a continuous band blade for cutting a workpiece.

Japanese Laid-Open Patent Publication No. 2007-90458 discloses a band saw, in particular a handheld band saw, having a continuous band blade for cutting a workpiece. This handheld band saw has a housing, a pair of wheels rotatably that are disposed on the housing and are positioned away from each other, and a drive unit for rotating the wheels. The wheels support a continuous band saw blade such that the band saw blade moves around the wheels when the drive unit rotates the wheels. The band saw has a “cutting portion” between the wheels. At the cutting portion, the band saw blade is exposed outside for cutting a workpiece.

The band saw blade is generally parallel to an axis of the wheel supporting the band saw blade, however it is desired to direct a cutting edge of the band saw blade obliquely at the cutting portion in order to achieve deep cutting. Thus, in the Japanese Laid-Open Patent Publication No. 2007-90458, the wheels are not parallel to each other in order to achieve such arrangement of the cutting edge. When the saw blade operates, the band saw blade may gradually move in a thickness direction of the band saw blade, so that it is often necessary to adjust position of the band saw blade. Accordingly, there has been a need for improved band saws.

### SUMMARY OF THE INVENTION

One aspect of this disclosure includes a band saw having a housing, a pair of wheels rotatably disposed on the housing, a drive unit connected to one of the wheel, a continuous band saw blade supported by the wheels, and a guide movably attached to the housing. The guide is positioned to contact with the band saw blade in a thickness direction of the band saw blade.

In accordance with this aspect, the guide can be moved relative to the housing while restricting movement of the band saw blade in the thickness direction. Thus, it is able to reduce friction between the guide and the band saw blade by adjusting the position of the guide in order to minimize wear of the guide caused by such friction.

### BRIEF DESCRIPTION OF THE DRAWINGS

In the accompanying drawings:

FIG. 1 is a bottom view of a band saw having a movable guide;

FIG. 2 is an enlarged view showing the movable guide in FIG. 1;

FIG. 3 is a cross-sectional view showing the movable guide in a first embodiment;

FIG. 4 is an enlarged cross-sectional view of the movable guide in FIG. 3;

FIG. 5 is a cross-sectional view showing the movable guide in a second embodiment;

FIG. 6 is an enlarged cross-sectional view of the movable guide in FIG. 5;

FIG. 7 is a cross-sectional view showing the movable guide in a third embodiment;

FIG. 8 is an enlarged cross-sectional view of the movable guide in FIG. 7;

FIG. 9 is a cross-sectional view showing the movable guide in a fourth embodiment;

FIG. 10 is an enlarged cross-sectional view showing the movable guide in FIG. 9;

FIG. 11 is a cross-sectional view showing the movable guide in a fifth embodiment;

FIG. 12 is an enlarged cross-sectional view of the movable guide in FIG. 11; and

FIG. 13 is a perspective view of a variant of the movable guide.

### DETAILED DESCRIPTION OF THE PREFERRED EMBODIMENTS

Each of the additional features and teachings disclosed above and below may be utilized separately or in conjunction with other features and teachings to provide improved band saws. Representative examples, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

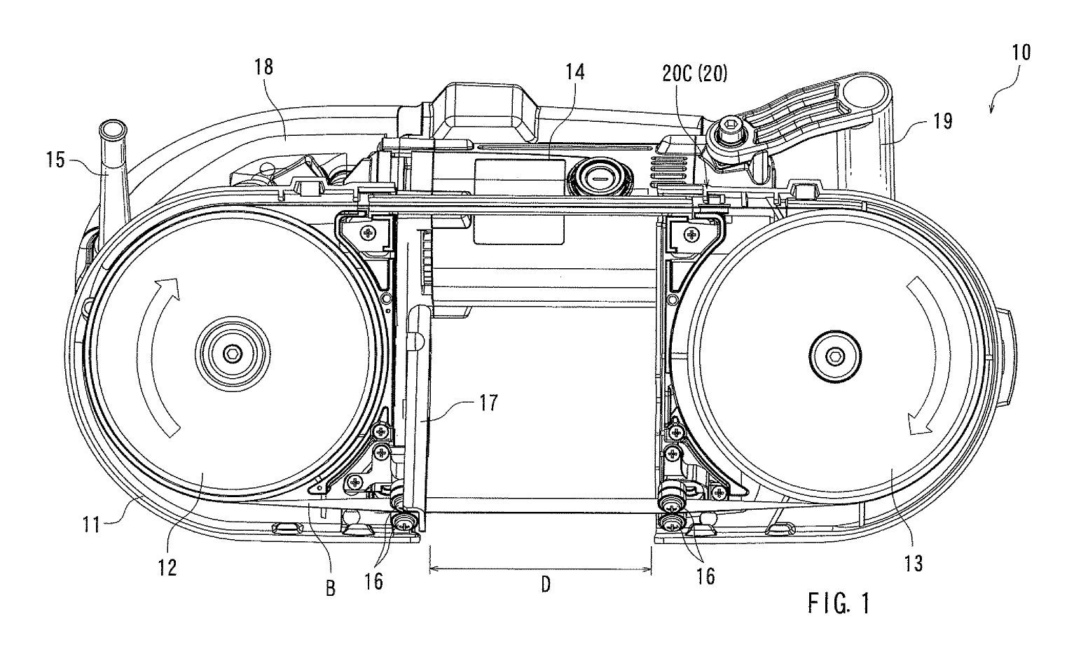

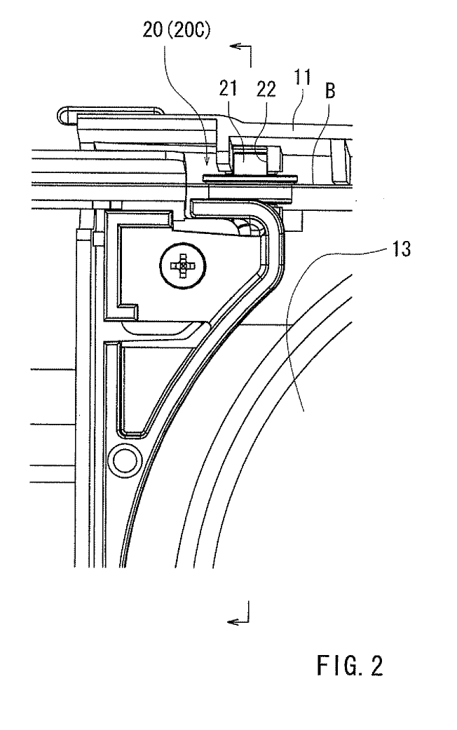

A first embodiment of this disclosure will be described in reference to accompanying drawings. FIG. 1 is a bottom view of a band saw 10 equipped with a movable guide 20. FIG. 2 is an enlarged view of the movable guide 20. Here, although the movable guide 20 shown in FIGS. 1 and 2 corresponds to a movable guide 20C of a third embodiment, which is described below, because other configurations of the band saw 10 are substantially same among all embodiments, other configuration of the first embodiment will be described in reference to FIGS. 1 and 2.

The band saw 10 is configured as a handheld type, which is also called as portable band saw, and has a housing 11, a pair of wheels 12 and 13, and a drive unit 14 for rotating the wheels 12 and 13.

The housing 11 houses the pair of the wheels 12 and 13 therein and works as supporting structure for the band saw 10.

The wheels 12, 13 are positioned away from each other at a predetermined distance in the housing 11. The wheels 12 and 13 can rotate relative to the housing 11 and support a ring-shaped continuous band saw blade B such that the band saw blade 13 extends partially along circumferences of the wheels 12 and 13 (see FIG. 1). The wheel 12 (left one in FIG. 1) is connected to the drive unit 14 for receiving driving force from the drive unit 14, whereas the wheel 13 (right one in FIG. 1) is not connected to the driving unit 14 directly. Thus, when the wheel 12 rotates due to driving force provided from the drive unit 14, driving force is transmitted from the wheel 12 to the wheel 13 via the band saw blade B and thus the wheel 13 can simultaneously rotate.

The drive unit 14 has a brushed motor (not shown) for generating driving force and a gear mechanism (not shown) for adjusting the driving force and then transmitting it to the wheel 12 in order to rotate the wheel 12 at a desired speed. The brushed motor of the drive unit 14 is connected with an external power supply via a cord 15 for receiving electric power. Further, the housing 11 has grips 18 and 19 for holding the band saw 10 by hand.

As described above, the wheels 12 and 13 support the band saw blade B, which is a continuous band formed in a ring shape. Thus, when the wheel 12 rotates, the band saw blade B move around the pair of the wheels 12 and 13. On the band saw blade B, a cutting portion D is defined, where the band saw blade B does not contact with the wheels 12 and 13 and is exposed outside (see FIG. 1) such that the band saw blade B can contact a workpiece at the cutting portion D.

The band saw blade B is obliquely directed relative to a rotational plane of the band saw blade B at the cutting portion D. In particular, the housing 11 has guide rollers 16 at both sides of the cutting portion D for turning the band saw blade B. Thus, the guide rollers 16 direct the band saw blade B obliquely relative to the rotational plane of the band saw blade B, so that the band saw 10 can cut the workpiece deeply. In addition, the housing 11 has a guide plate 17 for guiding the workpiece when cutting.

Because the band saw blade B is obliquely directed relative to the rotational plane of the band saw blade B at the cutting portion D, the wheel 13 is obliquely disposed on the housing 11 in order to smoothly move the band saw blade B along the wheel 13. In particular, the right half of the wheel 13 contacting with the band saw blade B is positioned above the left half of the wheel 13 not contacting with the band saw blade B. Due to this configuration, when the band saw 10 operates, the band saw blade B may intend to move upwardly near and in front of the circumference of the wheel 13. Thus, the housing 11 has a movable guide 20 in order to prevent the band saw blade B from moving upwardly prior to engaging with the wheel 13 as shown in FIG. 2.

The movable guide 20 is movably attached to the housing 11 and is configured to facilitate engagement between the band saw blade B and the wheel 13. In particular, the movable guide 20 guides the band saw blade B moving from the wheel 12 to the wheel 13. The movable guide 20 can support the band saw blade B in both a width direction and a thickness direction of the band saw blade B. In particular, the movable guide 20 is configured to contact with the band saw blade B in the width direction and the thickness direction in order to restrict movement of the band saw blade B in the width direction and the thickness direction. Due to this configuration, the movable guide 20 can facilitate engagement of the band saw blade B with the wheel 13.

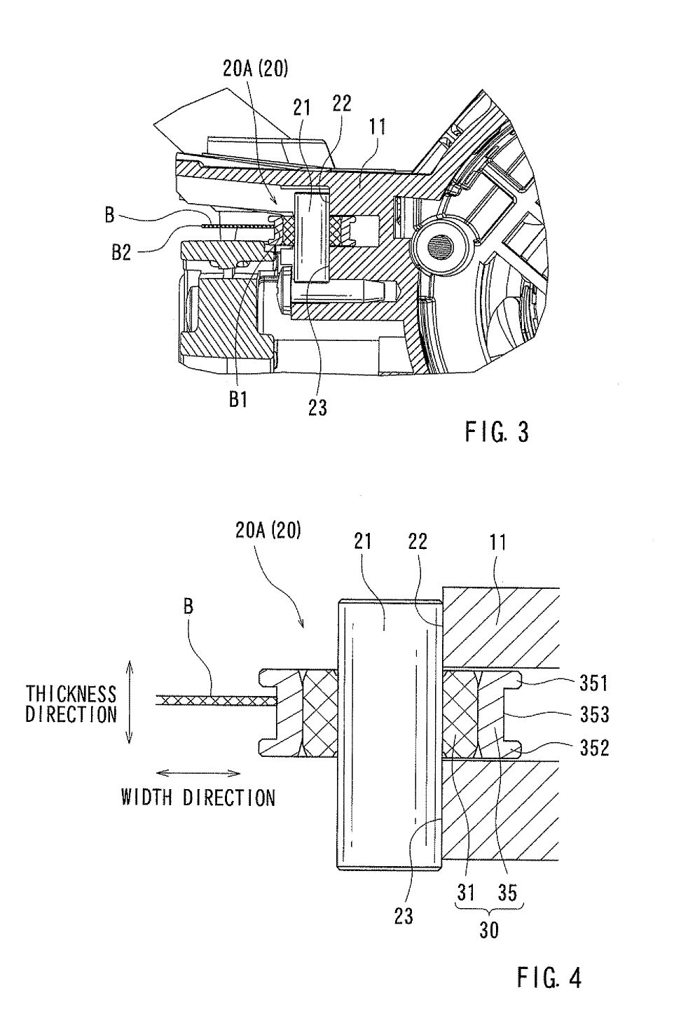

Some embodiments having variants of the movable guide 20 will be described below. Each of the movable guides 20A-20E in the embodiments basically has a fixed shaft 21 fixed on the housing 11 and a bearing for the fixed shaft 21. Thus, same configuration between the embodiments will not be described repeatedly. FIGS. 3, 5, 7, 9 and 11 are cross-sectional views showing the movable guide 20 (20A-20E) viewed along arrows in FIG. 2, respectively. In each of FIGS. 3-12, the vertical direction corresponds to the thickness direction of the band saw blade B, whereas the horizontal direction corresponds to the width direction.

Firstly, the movable guide 20A of the first embodiment will be described. FIG. 3 is a cross-sectional view showing the movable guide 20A. FIG. 4 is an enlarged cross-sectional view of the movable guide 20A. The movable guide 20A has a cylinder-shaped fixed shaft 21, which is fixed on the housing 11, and a bearing 30 disposed around the fixed shaft 21. The housing 11 has grooves 22 and 23 each formed in a rib shape in order to fixedly hold the fixed shaft 21. The fixed shaft 21 fixed on the housing 11 is inserted into the bearing 30. As shown in FIGS. 3 and 4, the bearing 30 is configured as sliding bearing. In particular, the bearing 30 has an inner ring 31 and an outer ring 35 disposed around the inner ring 31. The fixed shaft 21 is inserted into the inner ring 31 without backlash, and the outer ring 35 can smoothly slide along an outer circumference of the inner ring 31. Thus, the outer ring 35 can rotate relative to the fixed shaft 21 and thus the housing 11.

The outer ring 35 is formed in a sleeve shape and made of metal material, in particular iron. As shown in FIGS. 3 and 4, the outer ring 35 is positioned to contact with an edge B I of the band saw blade B.

That is, because the outer ring 35 is positioned to adequately restrict movement of the band saw blade B in the width direction, it is able to appropriately move the band saw blade B around the wheels 12 and 13. Here, the edge B1 is not configured as cutting edge, whereas another edge B2 opposite to the edge 131 is configured as cutting edge.

The outer ring 35 has a first regulatory portion 351 and a second regulatory portion 352 each formed in a flange shape in order to restrict movement of the band saw blade B in the thickness direction. The first regulatory portion 351 protrudes outwardly in a radial direction of the outer ring 35 from an outer end of the outer ring 35 (upper end in FIG. 4), whereas the second regulatory portion 352 protrudes outwardly in the radial direction from an inner end of the outer ring 35 (lower end in FIG. 4). Thus, the edge B1 of the band saw blade B is positioned to contacts with an outer circumferential surface 353 between the regulatory portion 351 and 352.

In accordance with the band saw 10 having the movable guide 20 of the first embodiment, because the housing 11 has the movable guide 20 capable of moving relative to the housing 11 and contacting with the band saw blade B in the thickness direction in order to restrict movement of the band saw blade 13 in the thickness direction, it is able to facilitate movement of the band saw blade B around the wheels 12 and 13 by restricting movement of the band saw blade B and to reduce friction between the movable guide 20 and the band saw blade B by adjusting position of the movable guide 20 depending on movement of the band saw blade B in order to minimize wear of the movable guide 20.

In accordance with the band saw 10 in the first embodiment, the movable guide 20 has the bearing 30 receiving the fixed shaft 21 that is fixed on the housing 11, so that it is able to reduce cost of the bearing 30 by using marketed product. In addition, because the outer ring 35 of the movable guide 20 has the regulatory portions 351 and 352, the movable guide 20 can restrict movement of the band saw blade B in the thickness direction in order to guide movement of the band saw blade B around the wheels 12 and 13.

Because the bearing 30 is configured as sliding bearing, it is able to use marketed product in order to decrease cost for manufacture. The regulatory portions 351 and 352 are formed by shaping each of the outer and inner ends in the flange shape, so that it is able to easily make the regulatory portions 351 and 352 for restricting movement of the band saw blade B in the thickness direction.

Therefore, in accordance with the first embodiment, it is able to guide movement of the band saw blade B around the wheels 12 and 13 and to decrease wear of the movable guide 20 caused by friction with the band saw blade B.

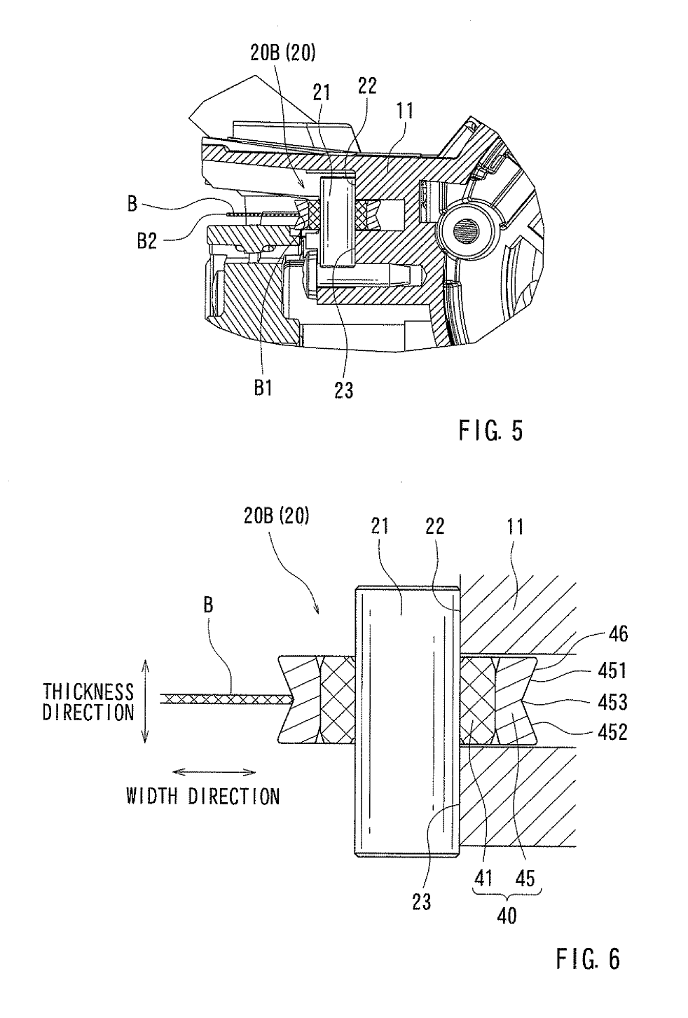

A second embodiment will be described. FIG. 5 is a cross-sectional view showing the movable guide 20B of the second embodiment. FIG. 6 is an enlarged cross-sectional view of the movable guide 20B. The movable guide 20B is different from the movable guide 20A of the first embodiment with respect to the outer ring 45 of the bearing 40 only, in particular the outer circumferential shape of the outer ring 45. So, such shape of the outer ring 45 will be mainly described, and other configurations will be described in brief.

The bearing 40 shown in FIGS. 5 and 6 is configured as sliding bearing and has the inner ring 41, which the fixed shaft 21 is inserted into, and the outer ring 45 that is disposed around the inner ring 45 such that the outer ring 45 can slide along the outer circumference of the inner ring 41.

The outer ring 45 has an outer circumferential surface 46 with a V-shaped groove 453 extending along the outer circumferential surface 46 in a circumferential direction. In particular, the outer circumferential surface 46 has a first surface inwardly inclining in the radial direction from the outer end (upper end in FIG. 6) of the outer ring 45 and a second surface inwardly inclining in the radial direction from the inner end (lower end in FIG. 6) of the outer ring 45 such that the V-shaped groove 453 are formed by the first surface and the second surface. In the second embodiment, the first surface corresponds to the first regulatory portion 451, whereas the second surface corresponds to the second regulatory portion 452. The V-shaped groove 453 is positioned to contact with the edge B1 of the band saw blade B in the width direction. The regulatory portions 451 and 452 formed as inclined surface on the outer circumferential surface 46 can operate similarly to the regulatory portions 351 and 352 of the first embodiment.

In accordance with the band saw 10 having the movable guide 20B of the second embodiment, because the outer circumferential surface 46 of the outer ring 45 has the V-shaped groove 453 defined by the regulatory portions 451 and 452, the regulatory portions 451 and 452 can guide the edge B1 of the band saw blade B toward a center of the V-shaped groove 453. Thus, when the edge B1 of the band saw blade B is not positioned at the center of the V-shaped groove 453, the band saw blade 13 is guided toward the center of the groove 453 by the regulatory portions 451 and 452, so that it is able to achieve smooth movement of the band saw blade B around the wheels 12 and 13.

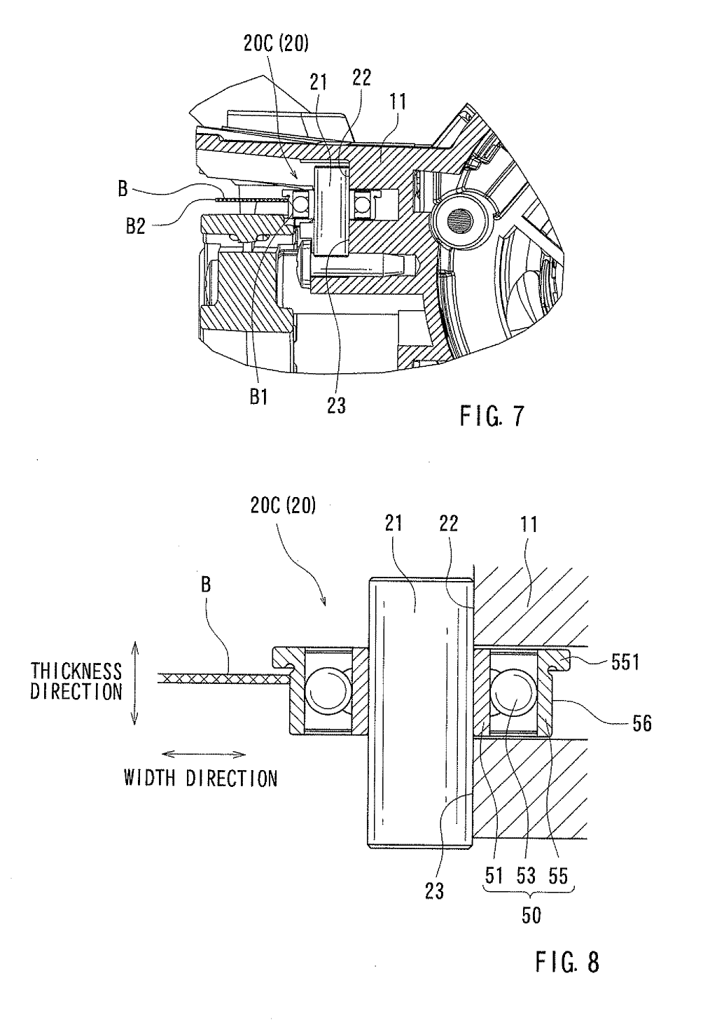

A third embodiment will be described. FIG. 7 is a cross-sectional view of the movable guide 20C of the third embodiment. FIG. 8 is an enlarged cross-sectional view of the movable guide 20C. The movable guide 20C is different from the movable guide 20A of the first embodiment with respect to the bearing 50 only. Thus, the bearing 50 mainly will be described, and other configurations will be described in brief.

The bearing 50 of the third embodiment is configured as ball bearing. Thus, the bearing 50 has an inner ring 51, which the fixed shaft 21 is inserted into, and an outer ring 55 such that balls 53 are disposed between the inner ring 51 and the outer ring 55. The outer ring 55 can rotate relative to the inner ring 51 by rotating the balls 53 between the inner ring 51 and the outer ring 55.

The outer ring 55 of the third embodiment has the outer circumferential surface 56, which is configured to contact with the band saw blade B, and the first regulatory portion 551 that is formed in a flange shape same as the first regulatory portion 351 of the first embodiment. The first regulatory portion 551 protrudes outwardly in the radial direction from the outer end (upper end in FIG. 8) of the outer ring 55. The outer circumferential surface 56 is positioned to contact with the edge 131 of the band saw blade B such that the first regulatory portion 551 restricts movement of the band saw blade B in the thickness direction.

In accordance with the band saw 10 having the movable guide 20C of the third embodiment, the movable guide 20C can restrict movement of the band saw blade B in the width direction and the thickness direction in order to enable smooth movement of the band saw blade B around the wheels 12 and 13 while decreasing wear of the movable guide 20C by adjusting position of the movable guide 20C.

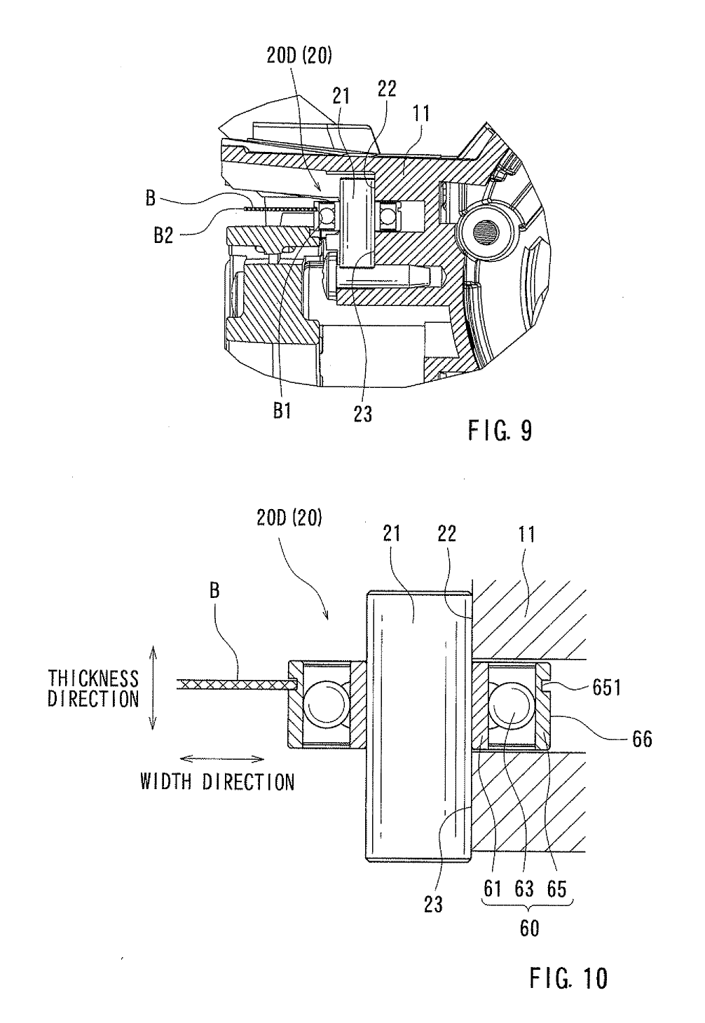

A fourth embodiment will be described. FIG. 9 is a cross-sectional view showing the movable guide 20D of the fourth embodiment. FIG. 10 is an enlarged cross-sectional view of the movable guide 20D. The movable guide 20D of the fourth embodiment is different from the movable guide 20C of the third embodiment with respect to the outer ring 65 of the bearing 60 only. Thus, the outer ring 65 will be described mainly, and other configurations will be described in brief.

The bearing 60 shown in FIGS. 9 and 10 has the inner ring 61, which the fixed shaft 21 is inserted into, and the outer ring 65 such that the balls 63 are rotatably disposed between the inner ring 61 and the outer ring 65.

The outer ring 65 has a groove 651 extending along the outer circumferential surface 66 of the outer ring 65 in the circumferential direction. In particular, the groove 651 is positioned near the outer end (upper end in FIG. 10) of the outer ring 65. A depth and a width of the groove 651 is determined such that the groove 651 can receive the edge B1 of the band saw blade B as shown in FIG. 10. Thus, the groove 651 can receive the edge B1 of the band saw blade B in order to restrict movement of the band saw blade B in the width direction and the thickness direction. That is, an inner facing surface of the groove 651 works as regulatory portion of this disclosure.

In accordance with the band saw 10 having the movable guide 20D of the fourth embodiment, the groove 651 can position the edge B1 of the band saw blade B in the thickness direction, so that it is able to achieve smooth movement of the band saw blade B around the wheels 12 and 13.

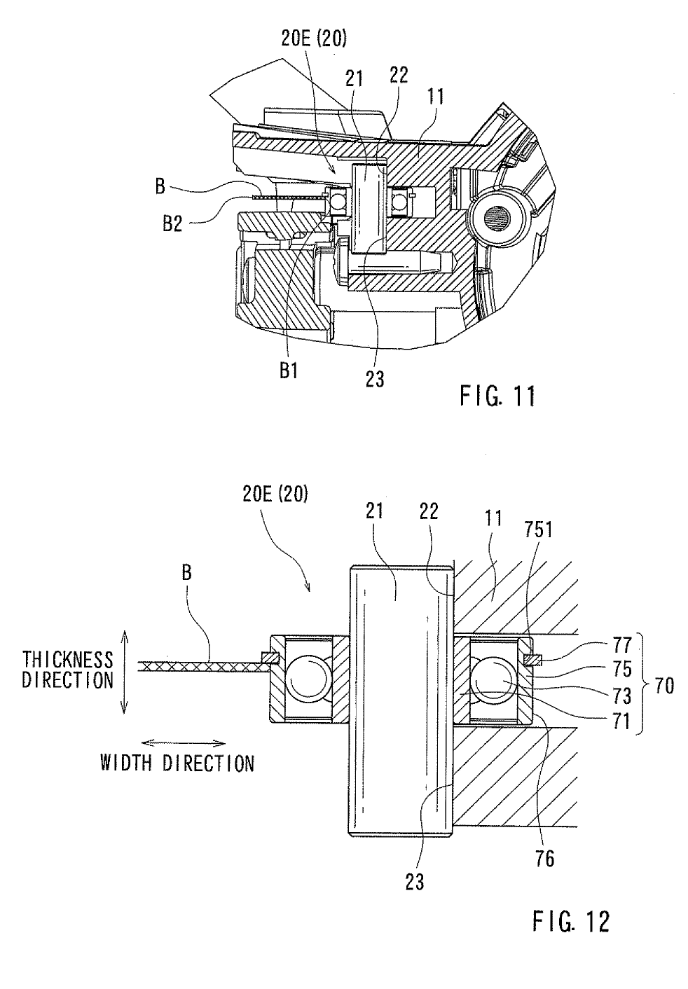

A fifth embodiment will be described. FIG. 11 is a cross-sectional view showing the movable guide 20E of the fifth embodiment. FIG. 12 is an enlarged cross-sectional view of the movable guide 20E. The movable guide 20E of the fifth embodiment is different from the movable guide 20D of the fourth embodiment with respect to the outer ring 75 of the bearing 70 only. Thus, the outer ring 75 will be mainly described, other configurations will be described in brief.

The bearing 70 has the inner ring 71, which the fixed shaft 21 is inserted into, and the outer ring 75 such that the balls 73 are rotatably disposed between the inner ring 71 and the outer ring 75.

The outer ring 75 has the groove 751 extending along the outer circumferential surface 76 of the outer ring 75 in a similar manner to the outer ring 65 of the fourth embodiment. The outer ring 75 additionally has a regulatory ring 77 that is partially received in the groove 751 as shown in FIG. 12. The regulatory ring 77 is formed in a ring shape and is elastically deformable. The regulatory ring 77 received in the groove 751 protrudes outwardly in the radial direction (horizontal direction in FIG. 12) from the outer circumferential surface 76. The length of the regulatory ring 77 protruding from the outer circumferential surface 76 is determined such that the regulatory ring 77 can contact with the edge B1 of the band saw blade B in order to restrict movement of the band saw blade B in the thickness direction. That is, the regulatory ring 77 works as regulatory portion of this disclosure for restricting movement of the band saw blade B in the thickness direction in order to enable smooth movement of the band saw blade B around the wheels 12 and 13.

In accordance with the band saw 10 having the movable guide 20E of the fifth embodiment, the movable guide 20E can restrict movement of the band saw blade B in the width direction and the thickness direction in order to enable smooth movement of the band saw blade B around the wheels 12 and 13 while decreasing wear of the movable guide 20E by adjusting position of the movable guide 20E.

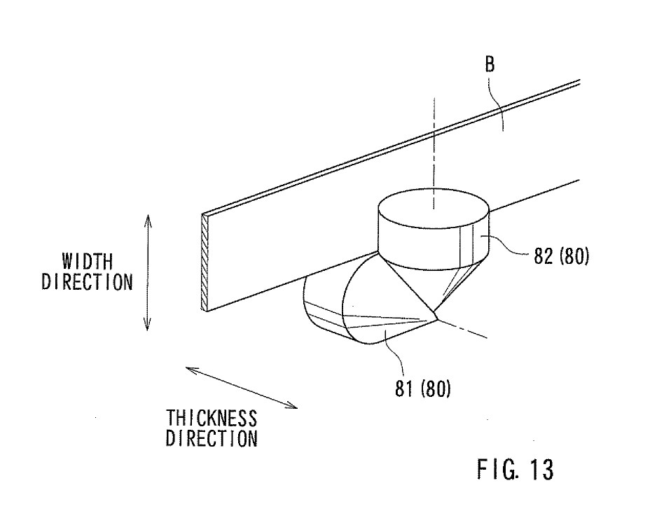

The present invention is not limited to the above-described embodiments and can be further changed as necessary. For example, FIG. 13 is a perspective view of another movable guide 80 without the bearing. The movable guide 80 has a first roller 81 contacting with one of broad surfaces of the band saw blade B and a second roller 82 contacting with the edge of the band saw blade B. The second roller 82 can move relative to the housing and restrict movement of the band saw blade B in the thickness direction, so that the movable guide 80 can reduce friction between the second roller 82 and the band saw blade B in order to minimize wear of the movable guide 80. That is, the movable guide of this disclosure may include the second roller 82.

The invention claims:

1. A band saw comprising:
a housing;
a pair of wheels rotatably disposed on the housing;
a drive unit connected to one of the wheel;
a continuous band saw blade supported by the wheels; and
a guide movably attached to the housing and positioned to contact with the band saw blade in a thickness direction of the band saw blade.

2. The band saw according to claim 1, wherein
the guide is composed of a shaft fixed on the housing and a bearing disposed around the shaft; and
the bearing has an outer ring being capable of rotatably moving relative to the housing, contacting with the band saw blade in its width direction and having a regulatory portion for contacting with the band saw blade in the thickness direction.

3. The band saw according to claim 2, wherein
the bearing is configured as a sliding bearing; and
the regulatory portion protrudes outwardly in a radial direction of the outer ring from one end of the outer ring.

4. The band saw according to claim 3, wherein
the outer ring has a second regulatory portion protruding outwardly in the radial direction of the outer ring from the other end of the outer ring.

5. The band saw according to claim 4, wherein
each of the regulatory portions is formed in a flange shape.

6. The band saw according to claim 4, wherein
each of the regulatory portions has a circumferential surface inclining inwardly in a radial direction toward one another.

7. The band saw according to claim 6, wherein
the regulatory portions form a V-shaped groove extending along an outer circumferential surface of the outer ring in the circumferential direction.

8. The band saw according to claim 2, wherein
the bearing is configured as ball bearing;
the outer ring has a circumferential surface contacting with the band saw blade in the width direction of the band saw blade; and
the regulatory portion protrudes outwardly in a radial direction of the outer ring from one end of the outer ring.

9. The band saw according to claim 2, wherein
the regulatory portion is a groove extending along an outer circumferential surface of the outer ring in a circumferential direction.

10. The band saw according to claim 9, wherein
the groove is positioned near an axial end of the outer ring.

11. The band saw according to claim 2, wherein
the outer ring has a groove extending along an outer circumferential surface of the outer ring in a circumferential direction; and
the regulatory portion is composed of a ring member that is partially received in the groove.

12. The band saw according to claim 11, wherein
the groove is positioned near an axial end of the outer ring.

13. The band saw according to claim 12, wherein
the bearing is configured as ball bearing.

14. The band saw according to claim 2 further comprising:
rollers disposed on the housing and guiding the band saw blade in order to incline the band saw blade.

15. The band saw according to claim 2, wherein
the wheels are positioned such that axes of the wheels intersect one another.
